(19) United States
(12) Patent Application Publication
(10) Pub. No.: US 2025/0077830 A1
(43) Pub. Date: Mar. 6, 2025

(54) Method for allowing robots or technologies to simulate and recognize character and type of relationship based on actions and carry out conflict and reconciliation processes

(71) Applicant: Guillermo Alvarez Pardo, Paso Robles, CA (US)

(72) Inventor: Guillermo Alvarez Pardo, Paso Robles, CA (US)

(73) Assignee: Guillermo Alvarez Pardo, Paso Robles, CA (US)

(21) Appl. No.: 18/812,984

(22) Filed: Aug. 22, 2024

Related U.S. Application Data
(60) Provisional application No. 63/579,511, filed on Aug. 29, 2023.

(51) Int. Cl. G06N 3/006

(52) U.S. Cl. CPC G06N 3/006

(57) ABSTRACT

This application relates to the fields of Artificial Intelligence, Affective Computing and Computer Sciences among others, and discloses a method for equipping a robot or other technological device with the ability to recognize character and type of relationship, simulate character and emotions, and trigger and carry out conflict and reconciliation processes with other actors, such as humans or other robots. The method includes: a novel model for personality and relationship characterization based on dimensions, here called Pat Palprolov; a novel model that allows for the characterization and recognition of personality and type of relationship on the basis of actions, here called the loom and fabric of actions; a novel model for robot behavior including an objective function, a system of dimensional values, weights and thresholds, and a pyramid of needs; and a model for stress and its effect on the intensity of the triggers.

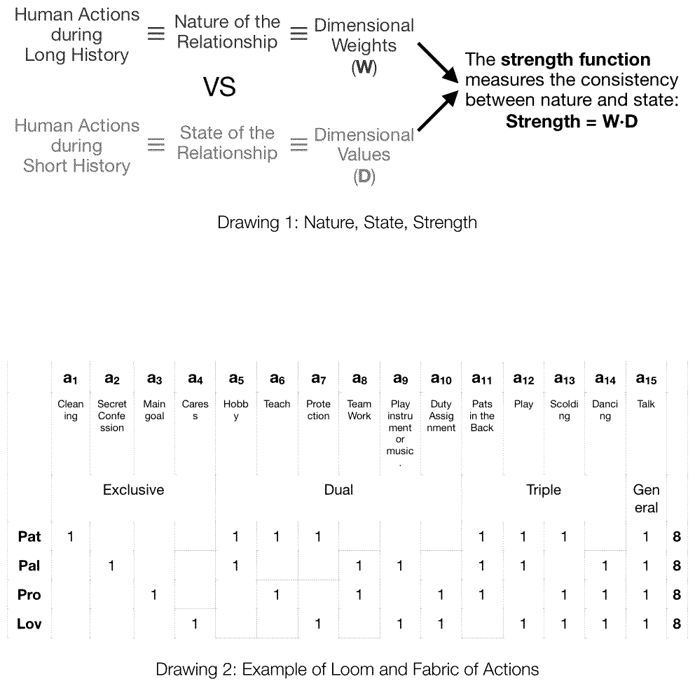

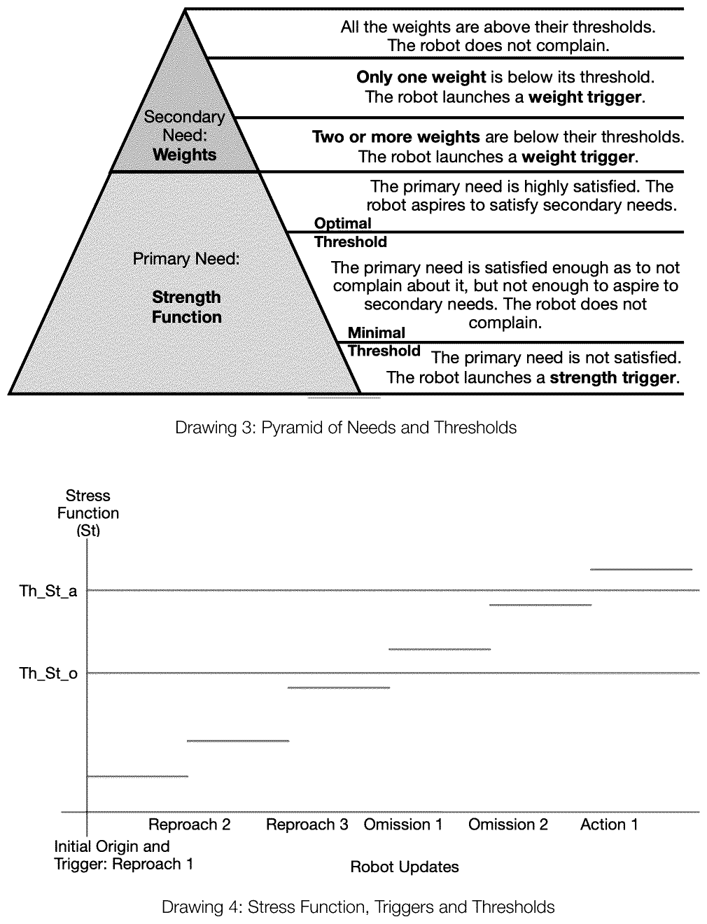

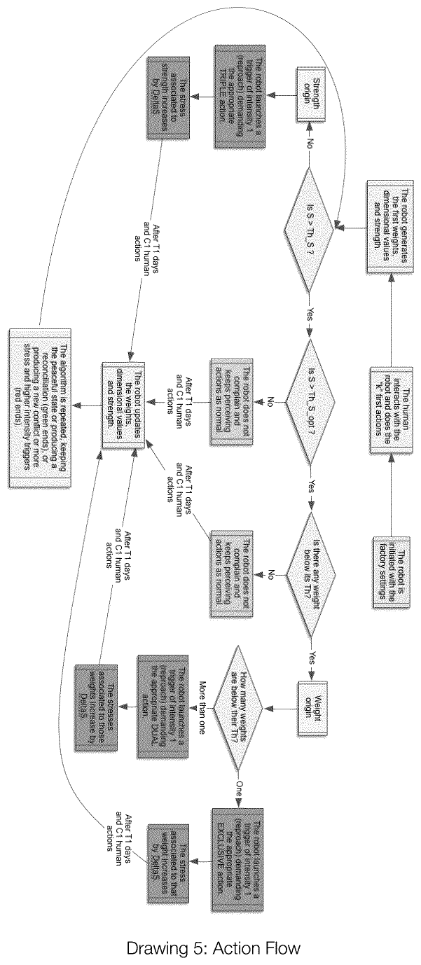

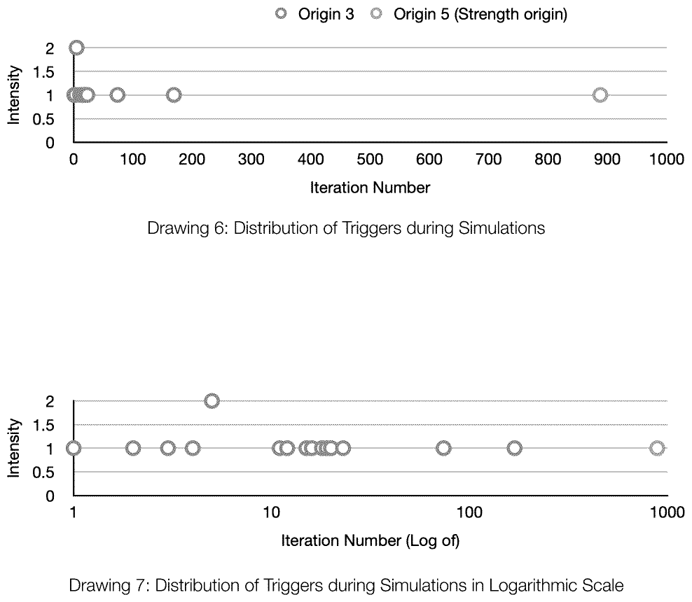

### CROSS-REFERENCE TO RELATED APPLICATIONS

This application is related to and claims the benefit of priority of USA provisional application 63/579,511, filed on Aug. 29, 2023.

Method for allowing robots or technologies to simulate and recognize character and type of relationship based on actions and carry out conflict and reconciliation processes.

VOCABULARY AND CONCEPTS

In the upcoming sections, some concepts will be defined that might be used in the claims. The author works then as his own lexicographer. Some of these concepts include: the Pat Palprolov model, the loom and fabric of actions, the weaving of actions throughout dimensions, the stress function, origins and triggers, the pyramid of needs and thresholds, dimensional values and weight values, strength function, the memory matrix, the nature and state as measured with the memory matrix and weight and dimensional values. Also, the concept of robot can be understood in a generic way. Not necessarily as a human-like or animal-like robot, but as any generic technological device able to interact with humans or other robots. For example, a car, an electric bike or a computer. It only requires the ability to identify each of the actions considered in the method, which are 15 or 16 in the specific embodiment introduced in the following sections. Other patent applications already granted and somewhat related to this application are discussed in the background section and included in the references section.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not applicable

### INCORPORATION-BY-REFERENCE OF MATERIAL SUBMITTED ON A COMPACT DISC Not applicable

### REFERENCES CITED

[1] U.S. Pat. No. 11,670,324 B2, Huawei Technologies, June 6, 2023.
[2] U.S. Pat. No. 11,226,673 B2, Shanghai Xiaoi Robot Technology, January 18, 2022.
[3] U.S. Pat. No. 10,593,349 B2, George Washington University, March 17, 2020.
[4] US Patent Publication US2018/0229372A1, JIBO INC, February 7, 2018.
[5] U.S. Pat. No. 9,786,299 B2, Microsoft Technology Licensing LLC, October 10, 2017.
[6] M. Argyle and M. Henderson, “The rules of friendship,”Journal of social and personal relationships, vol. 1, no. 2, pp. 211-237, 1984.
[7] M. S. Guide. (2021) Understanding conflict—meaning and phases of conflict. [Online]. Available: https://www.managementstudyguide.com/understanding-conflict.htm
[8] NAIAC: https://ai.gov/wp-content/uploads/2024/06/RECOMMENDATIONS_Harnessing-AI-for-Scientific-Progress.pdf
[9] Wikipedia: https://en.wikipedia.org/wiki/Affective_computing
[10] M. Spitale and H. Gunes, “Affective robotics for wellbeing: A scoping review,” in 2022 10th International Conference on Affective Computing and Intelligent Interaction Workshop and Demos (ACIIW). IEEE, 2022, pp. 1-8.
[11] N. Churamani, S. Kalkan, and H. Gunes, “Continual learning for affective robotics: Why, what and how?” in 2020 29th IEEE International Conference on Robot and Human Interactive Communication (RO-MAN). IEEE, 2020, pp. 425-431.
[12] L.-E. Imbernon Cuadrado,A. Manjarres Riesco, and F. De La Paz Lopez, “Artie: An integrated environment for the development of affective robot tutors,” Frontiers in computational neuroscience, vol. 10, p. 77, 2016.
[13] M. Chen, J. Zhou, G. Tao, J. Yang, and L. Hu, “Wearable affective robot,” IEEE Access, vol. 6, pp. 64 766-64 776, 2018.
[14] Maslow, A. H. (1943). A theory of human motivation. Psychological Review, 50(4), 370-396
[15] Esteban, Pablo Gomez, and David Rios Insua. “A model for an affective non-expensive utility-based decision agent.” IEEE Transactions on affective computing 10.4 (2017): 498-509.
[16] G. Alvarez-Pardo and E. Fabregas, “Conflict and Reconciliation Processes Between Affective/Social Robots and Humans,” in IEEE Access, vol. 11, pp. 114811-114824, 2023

### TECHNICAL FIELD

This application relates to the field of Computer Sciences, and more specifically to the fields of Artificial Intelligence and Affective Computing, and more specifically to the field of recognizing and simulating character and relationship type, and triggering and carrying out conflict and reconciliation processes.

### BACKGROUND OF THE INVENTION

The development and applications of Artificial Intelligence (AI) have kept growing for the last decades and have exploded in the last years. This explosion includes the popularization of tools such as Chat GPT and the emergence of concerns, controversy and new policies and legislations about AI.

On May 2024, the National Artificial Intelligence Advisory Committee (NAIAC), “formed by experts with a broad and interdisciplinary range of AI-relevant experience from across the private sector, academia, non-profits, and civil society”, issued a brief report under the title of “RECOMMENDATIONS: Harnessing AI for Scientific Progress”, [8]. The report started with the following:

“Rapid advances in artificial intelligence (AI) technology represent real scientific progress—and these developments can go on to accelerate scientific progress in other domains, as well. AI is a powerful tool for discovery and learning, and it has already proven its potential in particle physics, climate science, neuroscience, drug discovery, and elsewhere. AI can also be used to improve educational opportunities, better equipping the next generation of researchers.”

The report included only two recommendations, the first of which was:

“Need for sustained funding and investment in AI in science and support for education and training in scientific communities.”

Some of these applications to education and medicine can be seen in a branch of AI called Affective Computing. Affective Computing can be defined as “the study and development of systems and devices that can recognize, interpret, process, and simulate human affects.”

Several books, journals and conference proceedings explain in more detail what those applications could be and articulate about creations already developed or proposed. The patent registry also shows various creations already patented in the fields related to this application. The following paragraphs discuss some of these proposals and creations and the similarities and differences with the invention proposed in this application (the latter hereon also referred to as “my creation”).

The work of Spitale and Gunes, 2022, [10], reviews a decade (January 2013-May 2022) of literature on human-robot interactions for wellbeing. It identifies three challenges of affective robotics: first, understanding the fundamental mechanisms of human behavior; second, developing systems for robots to dynamically adapt to human behavior, meeting the needs of each individual and personalizing their behavior accordingly; third, transitioning from affective computing to a robot in a real-world context. The review also points out that a common problem with the current state of the art is that most robots are not fully autonomous and “researchers usually program human-robot interactions as a one off experience, for a limited scope and very short interaction durations (usually no longer than 20 minutes).”

My creation addresses the first two of these challenges satisfactorily. First, it includes a model for human behavior based on a utility function, a system of weights and thresholds and a pyramid of needs, modeling how humans identify types of relationships and personality, generate expectations and trigger and carry out conflict and reconciliation processes. Second, it includes a memory matrix and the loom and fabric of actions, that, together with the objective function and the system of weights, allows the robot to dynamically adapt to human behaviour. While the third challenge is still in the air, the simulations done suggest that the transition from my affective computing method to the actual robot in real-world context could be highly satisfactory.

The work of Churamini, Kalkan and Gunes, 2020, [11], focuses on continual learning (CL). It defends the importance of building systems with long-run memory, able to remember past interactions and personalize towards each user while also influencing the learning of novel expressions. On the other hand, it warns that a system with long-run memory “might require a lot of interactions before the model can successfully adapt, negatively impacting the initial user experience”; the authors point out that this could be ameliorated with adversarial training. It regrets that, in the existing approaches, few models focus on learning task-oriented behaviors.

My creation very much contributes to the concept of continual learning, since it includes the concept of memory matrix, and the concepts of “nature” and “state” of the relationship, where the former is about long-term history and more permanent, while the latter is about short-term history and more changeable. It very much influences the learning of novel expressions by demanding them when the thresholds are passed, which triggers a conflict and reconciliation process (CRP). Most importantly, my method can be set to demand the learning and practice in an even way (i.e., contributing evenly to all four dimensions of the relationship) or in a way more leaning towards some particular dimensions of a relationship. This flexibility allows us to aim at specific learning outcomes, specially useful for medical purposes. My creation, indeed, focuses on developing and learning task-oriented behaviors.

The work of Cuadrado, Reisco and Lopez, 2016, [12], points out that common affective measures based on physiological and psychological responses usually require intrusive and expensive tools that are impractical in real settings. In response, the authors propose an emotion recognition system based on typing dynamics and mouse interactions.

My creation is not based on biosignals and does not require any of the widely used intrusive and expensive tools that other creations utilize. Instead, it is based on a set of actions that the human (or other robot) is able to do and the robot is able to recognize, and in a system that allows the robot to determine the nature and state of the relationship and assess the possible need for demanding more or less of certain actions on the basis of the long and short record of actions previously executed by the human. While this is similar in its virtues to the method described in Cuadrado et al, it is also fully different in its specific elements.

The work of Chen, Zhou, Tao, Yang and Hu, 2018, [13], introduces a system for a robot to simulate types of personality characteristics, including brave, steady, sincere, kind-hearted, self-confident, tenacity, forward-looking, and optimistic. It relies heavily on a pre-existing tool called AIWAC smart box.

My creation is similar to this in that it also allows the robot to recognize and simulate types of personality or relationship, including the four of my Pat Palprolov model: Paternalistic, Pals, Professional and Love. However, my creation is different in all the specifics, very specially in the fact that it does not require of any previously existing smart box or model. It is, in this sense, a fully self-contained method, which uses only its own system of matrices, metrics, weights, thresholds and algorithms, and its own model for robot learning, to produce in the robot the desired human-like behavior.

The work of Esteban and Insua, 2019, [15], presents an affective model for an autonomous decision agent with the ability to be influenced by affective factors when interacting with humans and other agents. It uses a utility function defined as a dot product of two vectors, where one vector can be considered to be a vector of weights and the other a vector of objectives.

My creation is similar to this in that it also uses a utility function defined as a dot product of two vectors. However, the values for the two vectors are obtained in totally different ways. The authors resort to what is called “adversarial risk analysis” and use a complex system of probabilities, including expectations and conditional probabilities, and involving what they call “emotions”, “mood” and “surprise”. A differentiator of my creation is how the values of the vectors, what I call “weights” and “dimensional values”, are obtained simply with the record of actions from the long-run for the former and with the record of actions from the short-run for the latter, taken from what I call the memory matrix. That is why my system can be classified as mostly deterministic, while their system can be classified as mostly probabilistic. Also, in my method the values are highly tied to what I call the loom and fabric of actions, which has little to nothing to do with the source of values in their method.

The following are patents from the last eight years that have connections with the work presented in this application.

Patent U.S. Pat. No. 11,670,324 B2, granted to Huawei in 2023, [1], provides a method intended to allow a robot to simulate “sensibility” and “emonional needs in a manner similar to that of human beings, thereby gradually building trust and dependency.” Huawei's method is similar to others in that it uses signs coming from voice, expression, body, skin . . . while it is different from others in that it is able not only to determine the current emotional status, but also predict a future one.

This is similar to my creation in some of its goals. However, my creation does not aim at predicting emotional status, but at allowing the robot to identify and simulate character and type of relationship and trigger and carry out CRP. Also, my method tends to shape the behavior of the human interacting with the robot in a direction determined by its configuration parameters. Most importantly, the method of my creation does not share a single equation, metric, threshold or trait in general with the method described in the patent cited above.

Patent U.S. Pat. No. 11,226,673 B2, granted to Shanghai Xiaoi Robot Technology in 2022, [2], discloses an affective interaction apparatus able to capture emotion-related data from the user, and a method to recognize the emotional state of the user based on the emotion-related data. The method and apparatus collect the data by means of devices in the apparatus such as “Text Capturer”, “Voice Capturer”, “Facial Expression Capturer”, “Gesture Capturer”, “Physiological Signal Capturer” and “Multimodality Capturer”.

Very much like other creations cited above, this system relies heavily on inputs that are hard to capture, such as voice, gestures or physiological signals. On the contrary, my creation only uses as inputs actions done by the human (or any other actor), which are easy to detect and identify. Also, all the mathematical and computational model built into my creation shares nothing with the method included in this other patent.

U.S. Pat. No. 10,593,349 B2, granted to The George Washington University in 2020, [3], uses “emotional dimensions include at least activation, valence, and dominance, and the at least three levels of emotional dimensions include a high state, a neutral state, and a low state.”

Qualitatively, the use of emotional dimensions in this patented creation might resemble the use of personality and relationship dimensions (Pat Palprolov model) included in my creation, and the use of three levels of emotional state (high, neutral and low) might resemble how my method handles the concept of “stress” and the three thresholds for the three intensities of a possible trigger: reproach (the robot speaks with a reproach), omission (the robot ceases to obey), and action (the robot engages in disruptive behavior). However, quantitatively, the architecture, equations and all the specifics of my method are completely different from anything used in the other creation.

U.S. Pat. No. 20,180,229372 A1, granted to JIBO Inc in 2018, [4], discloses a method that allows a robot to deliver expressions that contain emotion and tone that look authentic, believable and understanding, and which are appropriate to the context of the interaction; therefore, looking like human and not robotic.

This is qualitatively similar to how my creation aims at having the robot trigger and carry out CRP which are consistent with the behavior of the human. But, again, the quantitative aspect of my method has nothing to do with this granted patent.

U.S. Pat. No. 9,786,299 B2, granted to Microsoft Technology Licensing in 2017, [5], classifies emotion types based on dialog.

This can be compared to how my method classifies relationship types. However, my method does it based on actions and uses a completely different mathematical and computational model.

In essence, my creation provides a not-obvious method that aims at something quite novel in the field (the ability for robots to identify type of relationship on the basis of actions and be able to simulate character and carry out conflict and reconciliation processes with humans and with other robots), and such method involves a novel computation and mathematical model.

The method can be said to have the following virtues: 1) It allows the robot to dynamically adapt to human behavior, meeting the needs of each individual and personalizing their relationship accordingly. 2) It is fully autonomous; potentially, with no human interaction needed once set up. 3) It is programmed to run for thousands of iterations in weeks or months, in a sort of long-run continuous learning. 4) It allows for shaping the user, especially their task-oriented behavior, with clear applications for education and therapeutic purposes. 5) It does not require invasive or expensive tools, with the additional benefit of not depending on cloud services or network connections. 6) It does not rely on previous chips or smart boxes, making it self-contained and inexpensive. 7) Its inputs are actions, which are easy to identify, rather than biosignals, voice, gestures, etc., much more difficult to capture.

As a final comment, the method object of this patent application was disclosed in the paper titled “Conflict and Reconciliation Processes between Affective/Social Robots and Humans”, published

on Sep. 7, 2023 in IEEE Access, [16], where further discussion about the creation is included.

### BRIEF SUMMARY OF THE INVENTION

The method disclosed in this application is built upon the following pillars:
1. The idea that there are four essential types of relationships: between parents and children, between friends or fellas, between colleagues or coworkers, and between spouses or romantic partners. Those are the types of relationships for which the literature shows abundant studies about how conflict generates and resolves. The method is built upon the idea that those four types can also be understood as dimensions of a relationship and dimensions of a personality. These dimensions are here called paternalistic, pals, professional and love, and referred to by the name of Pat Palprolov.
2. The loom and fabric of actions. This is a device that allows a set of actions to be woven throughout a number of dimensions according to certain criteria, in such a way that the actions participate evenly of the dimensions, which allows for the characterization of the person executing actions based on which actions they execute. It also allows for each action to be identified with a vector containing Os and 1s. In the upcoming embodiment, we will consider four dimensions, coming from the Pat Palprolov model, although any other number of dimensions could be used with the same method.
3. A memory matrix. This is a matrix that stores a fixed number of actions and allows the robot to define “nature” and “state” of the relationship based on the long-run and short-run memory of actions.
4. Objective function and system of weights and dimensional values. This is composed of mathematical and computational definitions for the dimensional values and dimensional weights that produce, with the usual dot product, the value of the objective function, here called strength function.
5. Pyramid of needs and system of thresholds. The method object of this application assumes that needs follow a hierarchy, in such a way that only when the basic ones are covered will the robot pursue the higher ones. This is similar to what Maslow said,
1943, on human motivation, [14]. This phenomenon is quantified with a system of thresholds for the objective function and the weights.
6. Triggers and its classification and resolution. A trigger is the reaction that the robot uses to initiate a conflict and reconciliation process (CRR). The criteria to launch a trigger is given by the system of dimensional weights and values, utility function and thresholds and so is the criteria to consider the CRR finished. The triggers are classified according to their intensity, and we have three types: reproach (low intensity), omission (medium intensity) and action (high intensity).
7. Stress function. This function determines when the robot will increase the intensity of the trigger and when the robot will consider the CRP finished (what we call reconciliation)

The applications of robots or technologies equipped with the method disclosed here could easily include (but without being limited to) the following: i) children with syndromes in the spectrum of autism; ii) veterans or other individuals suffering from PTSD, iii) elder persons suffering from loneliness, iv) more generally, any person who could benefit from training in emotional skills, such as empathy, or any person who would benefit from a robotic pet, iv) more generally, any person who could benefit from a more bonding experience with a robot. The fields that could benefit from the method descried here could include (but without being limited to): i) costumer service, ii) user experience, iii) education, iv) therapeutics.

It is worth noticing that, while the method disclosed here focuses on the affective dimension of human-robot interactions, the method also allows for the practice and training of regular actions; more specifically, any actions that the programmer might want to include in the loom and fabric of actions. In this way, a patient could practice their singing skills, or their coordination in exercises with the hand, or their memory, while in the long run getting also training in emotional skills.

### DETAILED DESCRIPTION OF THE INVENTION

### 1 A Brief Theory about Conflict and Reconciliation Processes

### 1.1 Pat Palprolov. A Personality and Relationship Model

A novel structure is introduced here. It is based on four categories that are considered to be dimensions of a relationship and dimensions of a personality. These dimensions are here named paternalistic, pals, professional and love, shortened with the acronym Pat Palprolov or PPPL. The following are brief descriptions of the nature of each:
1. Paternalistic Dimension. This has to do with treating the other as someone whose education, security, well-being or happiness one is responsible for. It includes actions such as supporting, patronizing or expressing love. It is the only non-symmetric dimension, in the sense that one part plays the role of parent, while the other plays the role of child, which are very different from each other.
2. Pals Dimension. This relates to the usual interactions between friends. M. Argyle and M. Henderson, 1984, [6], provide a cross-cultural characterization of friendship which involves six significant rules: stand up for a friend in their absence, share important news, provide emotional support, trust and confide the other, volunteer help and make the other person happy.
3. Professional Dimension. This is tied to the specificities of the relationships between peers, coworkers or colleagues. More formal and distant interactions take place in this context. Expressions of affection are not expected. Shared activities usually involve problem-solving or working to accomplish a particular goal.
4. Love Dimension. This emphasizes the expression of affection. It is the farthest from the professional dimension and somewhere between the pals dimension and the paternalistic dimension.

They are considered to be dimensions of the personality and dimensions of a relationship because everybody has the ability to lean towards one or another dimension and combine several of them, and every relationship participates in each of them to some extent. For example, the relationship between two peers at their workplace will participate mostly in the professional dimension, with its characteristic formality and goal-oriented interactions; however, casual conversations or interactions, as if they were pals, will be likely to take place too; one part may very well feel inclined to protect the other in a variety of scenarios, which would relate to the paternalistic aspect; and expressions of personal appreciation or affection will not be totally discarded, which leaves room for the love dimension. Similarly, one could have a personal inclination to interact with people in a fashion more sided with the paternalistic, pals, professional or love dimensions.

### 1.2 Structure of a CRP

Different structures have been proposed for the analysis of a CRP. The Management Study Guide considers five phases: Prelude, Triggering Event, Initiation, Differentiation and Resolution. To serve the system introduced in this application, the author introduces the distinction between the following elements or moments in time. The upcoming definitions include references to the mathematical model that will be fully explained in Section 2.
1. Origin. The origin is the element that one part perceives as a reason to initiate a CRP or the element that impels one part to initiate a CRP. The origin is often a combination of factors or influences. The origin will be tied to elements of the CRP system that will be called strength function, dimensional weights, and their respective thresholds.
2. Trigger, actor and reactor. The trigger is the action that one part takes to initiate a CRP. In human-human relationships, such action is sometimes taken in a more unconscious way, that is, without being part of a conscious CRP strategy. Such a distinction will not apply when a robot launches a trigger, as the concept of unconsciousness in robots is still a matter of debate. The actor is the part that launches the trigger and the reactor is the part that reacts to it.
   The embodiment introduced in this application is limited to the case in which the robot is the actor and the human is the reactor. In other words, the system focuses on making the robot detect origins and launch appropriate triggers. These triggers are classified into three categories, reproach, omission and action, according to their intensity, and such intensity is determined with the help of the stress function and the respective thresholds.
3. Realization. This is the moment when the reactor realizes that the actor has initiated a CRP. For practical reasons (as the system works from the perspective of the robot), it can also be defined as the moment at which the actor realizes that the reactor has realized that a CRP has been initiated.
   In the current embodiment, the robot will assume realization unless time passes and no significant reaction comes from the human. If the latter occurs, the robot will accumulate stress and may escalate to a more intense trigger.
4. Negotiation. The negotiation is the exchange of ideas or actions that takes place, usually initiated by the reactor, as part of an attempt to solve the conflict.
   In the present system, the negotiation is tied to the triggers that the robot is able to launch and the different sets of reactions that the robot can detect and recognize from the human. In particular, the negotiation starts when the robot launches its first trigger and consists of an exchange in which the human provides actions and the robot replies with different intensities for the same trigger, with different triggers or with a reconciliation signal.
5. Reconciliation. This takes place when both parts are satisfied, which puts an end to the CRP. The actor is usually the part that determines, with explicit agreement, the moment at which reconciliation occurs.
   In the embodiment introduced in this application, reconciliation occurs when the strength function or dimensional weights return to the correct levels as determined by the thresholds (they had to be below those levels for the robot to launch a trigger in the first place). The robot explicitly expresses that reconciliation occurs by performing the reconciliation signal.

### 2 A Mathematical Model for CRP

### 2.1 The Loom and Fabric of Actions

The device here called loom and fabric of actions works on the basis of certain dimensions that are used as warp yarns throughout which a set of actions is woven, with these actions working as the weft. The loom and fabric of actions could be based on any number or type of dimensions, although, in the following embodiment, we will use the four dimensions of the Pat Palprolov model introduced above.

For any particular set of dimensions, various sets of actions could be integrated into the loom and fabric of actions. The following are some guidelines for designing the set of actions and a particular set of actions as an example. The formulas included in the following section are based on an embodiment that uses only four dimensions; with more dimensions, the formulas would be different.

### 2.1.1 Some Guidelines for the Loom and Fabric of Actions

1. The actions should be as easy to perform, in such a way that only the human's inclinations determine what actions the human performs more often.
2. The actions should be tied to the four dimensions of the relationship in an even way, so that if the actions were performed randomly, the four dimensions would tend to have equal values. This also guarantees that the four dimensions reflect the human's preferences.
3. Different actions should participate in different dimensions to different extents. This allows the dimensions to evolve in one or another direction depending on how the human behaves.
4. Exclusive, dual, triple and general actions. A simple way of weaving all actions differently but evenly throughout the four dimensions is to consider four categories of actions:
   Exclusive actions contribute towards only one dimension. We would need to have ₄C₁h=4h actions like this, for any natural number h.
   Dual actions contribute towards only two dimensions. We would need to have ₄C₂r=6r actions like this, for any natural number r.
   Triple actions contribute towards three dimensions. We would need ₄C₃s=4s of these actions, for any s natural number.
   General actions contribute towards the four dimensions. We would need ₄C₄q=q of these actions, for any natural number q.

### 2.1.2 An Example of Fabric of Actions

Drawing 2 presents a fabric of actions that matches the guidelines stated above and uses h=r=s=q=1. This gives a total of 15 actions. We can also consider a very special 16th action, namely the null action, i.e., no action. As shown in the table, each action can be identified with a vector in {0, 1} 4 and each dimension is tied to eight actions. The headers include a brief name for each action, which refers to an example of the instrumentation of that particular action.

### 2.2 The Memory Matrix. Nature and State of the Relationship

The memory matrix, M, is a matrix in [symbol] _{×4} (R), where k is the number of actions that the robot can remember. Each action realized by the human is stored in M starting from its bottom. When M is filled, the action stored in the first row is removed to leave room for the new action, stored in the k^{th} row. Each of the four dimensions of the relationship is stored in a different column. The concepts of nature and state of the relationship are defined on the basis of all the actions stored in M for the former and just the last actions for the latter.

The nature of the relationship is identified with the dimensional weights, stored in vector W:

$$Action Load := {\sum }_{i = 1}^{k} {\sum }_{j = 1}^{4} {M}_{i j}$$

$${w}_{P a t} := \frac{{\sum }_{i = 1}^{k} {M}_{i 1}}{Action Load}$$

$${w}_{P a l} := \frac{{\sum }_{i = 1}^{k} {M}_{i 2}}{Action Load}$$

$${w}_{P r o} := \frac{{\sum }_{i = 1}^{k} {M}_{i 3}}{Action Load}$$

$${w}_{L o v} := \frac{{\sum }_{i = 1}^{k} {M}_{i 4}}{Action Load}$$

$$Clearly , {w}_{p a t} + {w}_{p a l} + {w}_{p r o} + {w}_{l o v} = 1$$

Let d∈{1,2, . . . , k} be the duration of a state, i.e., the number of actions that the robot will consider to define the state of the relationship. d should be a small number compared to k, for example,

$$d \leq \frac{k}{5} .$$

Two reasonable numbers would be k=1000 and d=200.

The state of the relationship is identified with the dimensional values, stored in the vector D. At any time, the values of the dimensions are defined as:

$$Pat := \frac{{\sum }_{i = k - d}^{k} {M}_{i 1}}{d}$$

$$Pal := \frac{{\sum }_{i = k - d}^{k} {M}_{i 2}}{d}$$

$$Pro := \frac{{\sum }_{i = k - d}^{k} {M}_{i 3}}{d}$$

$$Lov := \frac{{\sum }_{i = k - d}^{k} {M}_{i 4}}{d}$$

Notice that Pat, Pal, Pro, Lov €∈[0,1].

### 2.3 Strength Function

The system uses a multi-attribute additive utility function,, that measures the strength of the human-robot relationship, understood as the consistency between the state of the relationship (represented with the dimensional values, D) and its nature (represented with the dimensional weights, W):

$$S ( D , W ) := D \cdot W = {w}_{p a t} Pat + {w}_{pal} Pal + {w}_{p r o} P r o + {w}_{lov} Lov$$

Since the strength function is defined as the dot product of nature and state, it will tend to throw high values when both are consistent with each other and low values when they are not. See Drawing 1.

### 2.4 Origins

This section describes the way in which the robot perceives and reacts to origins.

### 2.4.1 Hierarchy of Needs and Thresholds

The idea that needs adhere to a hierarchy, and so do desires and expectations is subscribed here. Drawing 3 shows the pyramid used in the system. When the primary needs are satisfied above a certain standard, the individual begins concerning about secondary ones. In this system, the strength function is the primary need: the robot will want to maintain its values above a minimum standard, designated Ths, the threshold under which the robot perceives an origin.

When the strength function is above an optimal standard, designated Th_{S}_{ₒₚₜ}, the robot will be concerned about its secondary needs, which are considered to be the dimensional weights.

The underlying rationale is as follows. The robot expects, before all, consistency from the human, measured through the strength function, S. However, the robot also wants the relationship to participate to a certain extent in each of the four dimensions. In other words, the robot does not want high values of S obtained on the basis of over-developing some dimensions and neglecting others. This is formalized using thresholds for the dimensional weights: Th_{w}_{ₚₐₜ}, Th_{w}_{ₚₐₗ}, Th_{w}_{ₚᵣₒ}, Th_{w}_{ₗₒᵥ}. The robot will detect an origin if, while having S>Th_{S}_{ₒₚₜ}, any of the dimensional weights is below its respective threshold.

### 2.4.2 Stress

The system considers the concept of stress as something that accumulates during an undesired situation. The stress function, St, will be fueled by any origin, will increase as the origin holds in time and will determine the moments at which the robot will escalate its complaint, i.e., it will determine the intensity of the trigger. It is a monotonic increasing function, except when reset to 0. The latter occurs when there is a change in origin or when there is no longer an origin, i.e., when reconciliation has taken place. It adheres to the following guidelines:
1. Stress increases if the origin detected in the previous update is present in the new update.
2. Stress increases even more if the situation tied to the origin detected in the previous update has worsened. For example, if in the previous update there was a weight origin produced by wₗₒᵥ<Th_{w}_{ₗₒᵥ} and in the new update the new wloy is even less than the previous one, the stress will increase even more.

The following equations model these guidelines. Δ_{St} is the minimum increment in stress in each update if the origin detected in the previous update still holds. The subscript −1 refers to the value in the previous update. The equations for stress are the same for strength origins as for weight origins, so they can be shown at a time for any E∈{wₚₐₜ, wₚₐₜ, wₚₐₜ, wₚₐₜ, S}.

If E≥Th_{E}, then St_{E}=0

### Else:

if E≥E₋₁, then St_{E}=St_{E}+Δ_{St}
else,

$$S {t}_{E} = S {t}_{E} + {Δ}_{St} + 100 \frac{{E}_{- 1} - E}{{E}_{- 1}}$$

The expression

$$100 \frac{{E}_{- 1} - E}{{E}_{- 1}}$$

turns the percentage worsening of the origin into percentage points that get added to the stress.

Drawing 4 shows an example of the evolution of the stress function as the updates go by and the origin has not been cleared. It also shows how triggers are tied to stress, as explained in Section 2.5.

### 2.5 Triggers

This section introduces the classification of triggers and explains how the robot determines when and with what intensity to launch a trigger.

### 2.5.1 Classification of Triggers According to Origin and Demanded Action

When the origin comes from having S<Th_{S}, it is called a strength origin and the robot will demand a triple action: the triple action that participates in the dimensions with the three highest weights. This action is—besides the general action Talking:=1, 1, 1, 1)—the one that contributes the most to increasing the strength function, i.e., the maximum utility action from a deterministic perspective. For example, if the three highest weights are wₚₐₜ, wₚₐₗ, wₗₒᵥ, the action demanded by the robot will be a₁₂:=(1, 1,0,1).

If the origin comes from having S>Th_{S}_{ₒₚₜ} and one or more weights below their thresholds, it is called a weight origin. As in the case of strength origins, the demanded action will be the maximum utility action obtained deterministically:
1. If only one weight is below its threshold, the robot will demand the exclusive action associated to the dimension with the lowest weight. For example, if wₚₐₜ<Th_{w}_{ₚₐₜ}, the robot will demand action a₁:=(1,0,0,0). This is the action that will contribute the most to increasing the low weight.
2. If two or more weights are below their threshold, the robot will demand the dual action (triple actions are reserved for strength origins) associated with the dimensions with the two lowest weights. For example, if the two lowest weights are wₚₐₜ and wₗₒᵥ, the robot will demand action a₇:=(1,0,0, 1). Among dual actions, this is the one that contributes the most to increasing the lowest weights.

### 2.5.2 Classification of Triggers According to Intensity

According to their intensity, triggers are classified into three categories: reproach,

omission and action, corresponding to low, moderate and high intensity respectively. Drawing 4 shows the following:
1. When the robot detects an origin, its first reaction will be launching a reproach trigger. This is instrumented in the form of a sentence that refers to the origin. For example, if there is a weight origin tied to only wₚₐₜ<Th_{w}_{ₚₐₜ}, the demanded action will be a₁:=(1, 0,0,0):=Cleaning and the robot will say: “It has been too long since last time you cleaned me”. Once the reproach trigger is launched, the stress function begins to increase. It continues increasing if the human ignores the trigger or until the origin disappears. There are two thresholds for the stress function.
2. When the stress function exceeds Th_{St}_{ₒ}, the robot will launch an omission trigger. In this kind of trigger, the robot uses a similar sentence, but also stops obeying the human's orders. It might say something like: “Do you want me just to help you out? I also need attention”. The robot will begin questioning and declining to do some of the actions that are not the demanded action. This is the equivalent of a relationship that is malfunctioning because an unsolved conflict is going on.
3. When the stress function exceeds Th_{St}_{ₐ}, the robot will launch an action trigger. In this kind of trigger, the robot will adopt a disruptive behavior. This could be simply instrumented with sounds or flashing lights. The robot will completely stop listening to orders. This is the equivalent of a serious argument between the human and the robot. Since the robot will stop listening to orders that are not the one it demanded in its trigger, the origin should disappear sooner or later.

### 2.6 Negotiation and Reconciliation

Reconciliation occurs when the origin is cleared. The interval from the appearance of the origin to reconciliation, during which the robot launches triggers and the human responds to them, is the equivalent of the negotiation. During this negotiation, the human is expected to adjust their behavior according to the robot's triggers. Some extent of those adjustments is expected to stay with the human after the reconciliation. In other words, the whole CRP is expected to have positive permanent effects on the human and their relationship with the robot.

### 3 Structure of the Algorithm and Further Mathematical Considerations

This section discusses several considerations regarding the system. It also provides a simplified expression of the action flow of the system.

### 3.1 Considerations About Time

The robot will detect and store in the memory matrix any action at the moment it is performed by the human. However, the robot will update its dimensional weights, dimensional values and strength function only occasionally. Each update represents an opportunity for the robot to detect an origin and, therefore, launch a trigger. The robot will not detect any origin until the memory matrix has been filled for the first time. This allows the robot to assess the nature and state of the relationship for the first time. From this moment on, the robot will use the following parameters:
1. C₁ is the minimum number of human actions between two updates. An example of arbitrary but reasonable criteria is

$${C}_{1} \approx \frac{d}{2} .$$

Before, it was suggested to use

$$d \approx \frac{k}{5} ,$$

where d is the duration of the state and k is the size of the robot's memory matrix. In this way, the human has a fair chance to reshape the state of the relationship before the next update, and can also alter the nature of the relationship to some extent, since

$${C}_{1} \approx \frac{k}{10}$$

2. T₁ is the minimum number of days between two updates. While the appropriate value for this parameter will depend on the intended use of the robot, 7 or 14 days could be reasonable numbers for most scenarios.

After an update has occurred, the next one will take place as soon as both T₁ and C₁ have passed. This replicates human behavior in two ways. First, when a human involved in a relationship sees something they do not like, they usually do not complain immediately; they tend to wait for an appropriate moment. Second, if they have already complained, they usually do not expect an immediate solution; they tend to complain again, and perhaps escalate the complaint, if the situation has not been fixed after a reasonable period of time.

### 3.2 Weights, Strength and Stress. Action Flow

The following is a summary of the process and algorithm that the robot will use after having filled the memory matrix and each time that both T₁ and C₁ have passed from the previous update. The entire process is illustrated in Drawing 5.
1. Strength test. If Th_{S}≤S≤Th_{S}_{ₒₚₜ}, the robot will not launch any trigger. This would put an end to the negotiation (and thus produce a reconciliation) if the robot had launched a trigger in its previous update; it will put the stress function back to 0. Otherwise, the robot will perform the following:
2. If S<Th_{S}, the robot will perceive a strength origin and will launch a trigger. The demanded action will be determined by the values of the dimensional weights and the intensity will be determined by the stress function according to the criteria described in Section 2.5. Otherwise, we will have S>Th_{S}_{ₒₚₜ} and the robot will run the weights test.
3. Weights test. If there is at least one q∈{Pat, Pal, Pro, Lov} such that w_{q}<Th_{w}_{_{q}}, the robot will perceive a weight origin and will launch a trigger. The demanded action will be determined by the values of the dimensional weights and the intensity will be determined by the stress function according to the criteria described in Section 2.5. Otherwise, the robot will not launch any trigger. This would put an end to the negotiation (and thus produce a reconciliation) if the robot had launched a trigger in its previous update; it will put the stress function back to 0.

### 4 Simulations

The model introduced in the previous sections was implemented in Python with the default parameters for the robot being: k=1000, d=200, Th_{S}_{ₒₚₜ}=0.5, Th_{S}=0.4, Th_{w}=0.2, Delta_{Sy}=10, Th_{Sto}=50, Th_{Sta}=75, C₁=100. The program would receive actions from {0, 1}⁴ and would issue reactions expressed as a vector of the form (O_{S}, O_{w}, O_{w}, I, A₁, A₂, A₃, A₄), where the components O express the origin (strength, one weight or two or more weights), the component/expresses the intensity of the trigger (1 for reproach, 2 for omission, and 3 for action), and the components A correspond to the demanded action.

Two different types of simulations were performed: one in which a human would provide actions to the program and another in which another program would simulate the human and would provide the actions.

### 4.1 Simulations with a Human

This allowed us to try a variety of human behaviors, including those that aligned with the robot's demands and these which disregarded them. Several hundred iterations were done with both types. Thus, it was possible to study the behavior of the robot in the short run as a function of the human's actions and reactions. The following observations were made:
1. When the human tried to provide actions randomly, they indeed showed a preference for certain dimensions, which ultimately produced uneven weights, such as (0.21,0.28,0.25, 0.26).
2. When the human provided actions aligned with the robot's triggers, they managed to keep the robot happy and to have few triggers, neither of them of intensity 3 and very few of intensity 2. In contrast, when the human disregarded the robot's triggers, the latter escalated to intensity 2 and 3, especially after the occasions in which the human changed the dimensional nature of their most frequent action or when the human began providing the null action too often.

These experiences show that the robot is good at interacting with a human and noticing whether the human is paying attention to and caring for the robot or not, and is able to change their attitude if not enough attention or care is given.

### 4.2 Simulations with a Program Modeling a Human

To try thousands of iterations, we built a program capable of modeling the behavior of a human who pays reasonable attention to the robot's demands. This model identifies the human with a vector of R¹⁶ which is a probability distribution, Human Probabilities:=HP:=(p₁, p₂, p3, . . . , p₁₄, p₁₅, p₁₆). The sixteen components correspond to the probabilities that the human will do each action respectively. This comprises the fifteen actions included in our set of actions in Drawing 2, plus the null action with probability p16. These probabilities change when the robot launches a trigger, according to the trigger's demanded action and intensity, and evolve in time, in the absence of triggers, in a way consistent with observed human behavior. A balanced human would start with all actions and dimensions having similar probabilities, whereas an unbalanced human would have some actions and dimensions with substantially higher probabilities.

Three characteristics were studied and the following are the conclusions about them:
1. Convergence. Convergence was characterized as an equilibrium, i.e., as a prolonged absence of triggers, especially if the last ones took place further and further apart from each other. Convergence was achieved for both balanced and unbalanced humans, although more iterations and triggers were needed in the latter case. Drawing 6 and Drawing 7 show the distribution of triggers for 1,000 iterations with a very unbalanced human. It is visible how the triggers appear further apart from each other until they appear only incidentally.
2. Sensitivity. Once the equilibrium was achieved, there was the question of How much can the human change without producing a trigger? It turned out that the human can change their inclinations, i.e., the probabilities of their actions and dimensions, quite much and the robot would still not complain so far as the human keeps being as well-balanced as it was in the equilibrium. Triggers emerged only when the human became less well-balanced. Convergence was observed too after that. The extent of the human's balanceness was measured as a ratio between the probabilities of their most likely and least likely dimensions.
3. Replicability. Each series of iterations was repeated three times. This applies to both the series starting with the original HP and those starting with modifications in the HP after equilibrium was achieved. The results were essentially the same each of the three times.

The results of these simulations can be summarized in the following points:
1. The system shapes the human towards balanceness, staying in equilibrium for as long as the latter lasts.
2. The system will tend to launch triggers of intensity 1 if the human pays reasonable attention to its demands, whereas it will tend to escalate to intensities 2 and 3 if the human disregards its complaints.
3. The system is consistent on replication.

While the disclosure included here has been disclosed with some specifics (such as numbers or parameters), changes in these specifics could easily be done within the limits of the same method. Therefore, the spirit and scope of the present disclosure is not to be limited to the given examples or specific numbers or parameters, but it is to be understood in the widest way allowable by law. For example, an entire application of this method to educational purposes, and more specifically to the teaching of Mathematics, is already in development by the author. In such application, the Pat Palprolov model has been replaced by the GLAS model, where the four dimensions are Geometry, Logics, Algebra and Statistics, and the set of actions has been replaced by a set or corpus of mathematical exercises. In this context, as well as in other possible scenarios, the loom and fabric of actions is not tied to a model for characterization of personality or type of relationship, but for characterization of type of mathematical exercise. In general, the loom and fabric of actions can be used each time that we have some dimensions (we have used the example of 4 so far) used for characterization, where the characterization is done based on the values of those dimensions, and a set of items (actions, exercises, etc.) that participate of the dimensions according to the logics explained in the description in Section 2.1.

What is claimed is:

1. A method comprising:
Establishing a number of dimensions as part of a model for characterization based on the values that these dimensions take;
considering a number of items that are woven throughout the considered dimensions as in a loom and fabric of actions.

2. The method of claim 1, where the dimensions are four, corresponding to the Pat Palprolov model for personality and type of relationship characterization.

3. A method to determine nature and state, comprising:
Identifying or characterizing each item in a given collection of items as a vector whose coordinates are determined by the values of the considered dimensions;
storing a number of these vectors in a matrix;
using a number of the most recent vectors stored in the matrix to quantify in another vector, here called vector of dimensional values or state vector, the state of the relationship between the robot and the other actor, and using a much larger number of the most recent vectors stored in the matrix to quantify in another vector, here called vector of dimensional weights or nature vector, the nature of the relationship.

4. The method of claim 3, where further work comprises determining the strength of the relationship as a function of the state vector and the nature vector.

5. A method to determine origins, comprising:
Establishing a pyramid of needs with variables that represent at least a primary need and at least a secondary need;
considering thresholds for the primary needs and the secondary needs, including a minimal threshold and an optimal threshold for the variable of primary needs, and at least one threshold for each of the variables of secondary needs;
testing whether those thresholds are passed, in what here we call a threshold test, where an origin takes place when the variable of primary needs is below its minimal threshold, and the variables of secondary needs are tested against their thresholds if the variable of primary needs is above its optimal threshold, and an origin also takes place when the latter is true and any or some of the variables of secondary needs is/are below the respective thresholds.

6. A method to determine how to react to an origin, comprising:
Computing a stress function that accumulates as an origin stays unsolved, that is to say, as a threshold test is conducted and the variable that caused the origin stays beyond the required threshold;
using a collection of triggers adequate to the various origins, that is to say, to the various ways in which at least a variable could fail a threshold test;
considering at least two levels of intensity, where the intensity of the trigger is determined by the stress function.

7. The method of claim 6, wherein further work with the method comprises:
A system of reactions that the robot uses appropriate to the nature of the origin and its intensity, which are used to accompany each trigger or to express reconciliation when a new testing shows that neither of the threshold tests meets the conditions for a trigger.
